(19) United States
(12) Patent Application Publication
(10) Pub. No.: US 2018/0239504 A1
(43) Pub. Date: Aug. 23, 2018

(54) SYSTEMS AND METHODS FOR PROVIDING WEBINARS

(71) Applicant: CyberLink Corp., Shindian City (TW)

(72) Inventors: Jau-Hsiung Huang, New Taipei City (TW); Chen-Wei Chou, New Taipei City (TW)

(21) Appl. No.: 15/902,144

(22) Filed: Feb. 22, 2018

Related U.S. Application Data
(60) Provisional application No. 62/461,915, filed on Feb. 22, 2017.

(51) Int. Cl. G06F 3/0483; G06F 17/21

(52) U.S. Cl. CPC G06F 3/0483; G06F 17/211

(57) ABSTRACT

A representative method implemented in a webinar generation device for providing a webinar, includes: receiving a plurality of media content elements; receiving a first user input designating the plurality of media content elements in a predetermined order; receiving a second user input initiating broadcasting of the plurality of media content elements as a webinar based on the predetermined order; receiving a third user input, during the broadcasting of the webinar, selecting a second of the plurality of media content elements; and modifying the broadcasting of the webinar, in response to a fourth user input, such that the second of the plurality of media content elements is broadcast based on the fourth user input during the broadcasting of the webinar.

### CROSS-REFERENCE TO RELATED APPLICATION

This application claims priority to, and the benefit of, U.S. Provisional patent application entitled, “System and Method for Webinar,” having Ser. No. 62/461,915, filed on Feb. 22, 2017, which is incorporated by reference in its entirety.

### TECHNICAL FIELD

The present disclosure generally relates to web-based seminars and, more particularly, to systems and methods for providing webinars.

### BACKGROUND

When users want to produce a presentation for use in a web-based seminar (“webinar”) that contains media content, different editing software and media combination software applications are used to edit the media content and combine the different media content formats to generate the desired presentation.

In a conventional process, content capture devices (e.g., digital cameras) and media content editing software are used to record and edit media content that is to be used in a presentation. Additional media content combination software then is employed to integrate the various media content into a final presentation. The operation of the conventional process, owing to the different devices and software, tends to be inconvenient and time-consuming, particularly for users who may only use the devices and software occasionally. Therefore, there is a desire for improving these perceived shortcomings that existing technology has been inadequate for addressing.

### SUMMARY

Briefly described, one embodiment, among others, is a method implemented in a webinar generation device for providing a webinar, comprises: receiving a plurality of media content elements; receiving a first user input designating the plurality of media content elements in a predetermined order; receiving a second user input initiating broadcasting of the plurality of media content elements as a webinar based on the predetermined order; receiving a third user input, during the broadcasting of the webinar, selecting a second of the plurality of media content elements; and modifying the broadcasting of the webinar, in response to a fourth user input, such that the second of the plurality of media content elements is broadcast based on the fourth user input during the broadcasting of the webinar.

Another embodiment is a system for providing a webinar, comprising: a memory storing instructions; and a processor, having processor circuitry, coupled to the memory and configured by the instructions to: receive a plurality of media content elements; receive a first user input configured to designate the plurality of media content elements in a predetermined order; receive a second user input configured to initiate broadcasting of the plurality of media content elements as a webinar based on the predetermined order; receive, during the broadcasting of the webinar, a third user input configured to select a second of the plurality of media content elements; and modify the broadcasting of the webinar, in response to a fourth user input, such that the second of the plurality of media content elements is broadcast based on the fourth user input during the broadcasting of the webinar.

Another embodiment is a non-transitory computer-readable storage medium storing instructions to be implemented by a computing device having a processor, wherein the instructions, when executed by the processor, cause the computing device to perform steps, comprising: receiving a plurality of media content elements; receiving a first user input designating the plurality of media content elements in a predetermined order; receiving a second user input initiating broadcasting of the plurality of media content elements as a webinar based on the predetermined order; receiving, during the broadcasting of the webinar, a third user input selecting a second of the plurality of media content elements; and modifying the broadcasting of the webinar, in response to a fourth user input, such that the second of the plurality of media content elements is broadcast based on the fourth user input during the broadcasting of the webinar.

### BRIEF DESCRIPTION OF THE DRAWINGS

Various aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an embodiment of a system for providing webinars.

FIG. 2 is a schematic block diagram of an embodiment of a webinar generation device, such as may be used in the system of FIG. 1.

FIG. 3 is a flowchart of an embodiment of a method for providing webinars, such as may be performed by the system of FIG. 1.

FIG. 4 is a flowchart of another embodiment of a method for providing webinars, such as may be performed by the system of FIG. 1.

FIG. 5 illustrates an embodiment of an example user interface that may be provided by a webinar generation device.

FIG. 6 illustrates an embodiment of an example user interface operating in a record/edit mode.

FIG. 7 illustrates an embodiment of an example user interface operating in a broadcast recorded webinar mode.

FIG. 8 illustrates another embodiment of an example user interface operating in a slide mode.

FIG. 9 illustrates another embodiment of an example user interface operating in a picture-in-picture mode.

FIG. 10 illustrates another embodiment of an example user interface operating in a side-by-side mode.

FIG. 11 illustrates another embodiment of an example user interface operating in a video mode.

FIG. 12 illustrates another embodiment of an example user interface operating in a desktop screen-capture mode.

FIG. 13 illustrates another embodiment of an example user interface operating in a whiteboard mode.

FIG. 14 illustrates another embodiment of an example user interface operating in an animation mode.

FIGS. 15 and 16 illustrate another embodiment of an example user interface.

FIGS. 17-19 illustrate another embodiment of an example user interface.

FIG. 20 illustrates another embodiment of an example user interface.

FIGS. 21-24 illustrate another embodiment of an example user interface.

FIG. 25 is a schematic diagram illustrating an example method of modifying a media content element.

### DETAILED DESCRIPTION

Various embodiments of systems and methods for providing webinars are disclosed. As will be described in detail, in some embodiments, a user may readily select and edit a media content element of a presentation in real-time without having to record the entire presentation again. So configured, when the user broadcasts the presentation as a webinar, the user is able to interact seamlessly with the audience without having to disrupt the presentation to accommodate on-the-fly edits to the media content element and/or the order in which the media content elements are to be broadcast.

In the context of this disclosure, a media content element generally refers to a combination of one or more components that are often stored as a single file of a specified file type. By way of example, a media content element may be a Motion Picture Experts Group (MPEG) file that comprises audio-video content. Other examples of a media content element include, but are not limited to: audio or video (e.g., pre-recorded, live via a microphone or camera), a slide (e.g., a POWERPOINT slide), an image, desktop screen capture, white board, annotation, and animation. Each component of a media content element may further comprise one or more segments. Each segment may comprise audio-only content, video-only content, image content, or audio-video content, for example. In some instances, a user merges multiple segments into a single component. Multiple components may then be merged into and stored as a media content element.

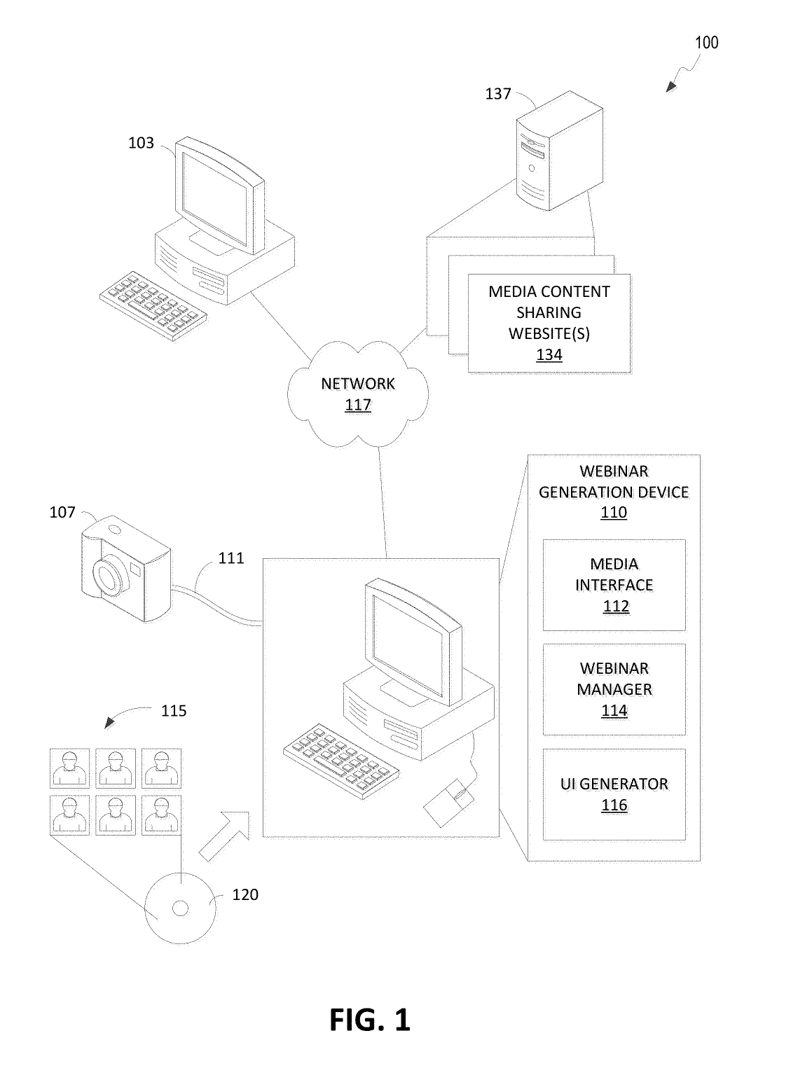

A description of an embodiment of a system for providing webinars is now described followed by a discussion of the operation of the components within the system. In this regard, FIG. 1 is a block diagram of a system 100 in which an embodiment of a webinar generation device 110 may be implemented. Webinar generation device 110 may be embodied as a computing device equipped with digital content recording capabilities such as, but not limited to, a digital camera, a smartphone, a tablet computing device, a digital video recorder, a laptop computer coupled to a webcam, and so on. Webinar generation device 110 is configured to receive, via a media interface 112, digital media content elements (e.g., media content element 115) stored on a storage medium 120 such as, by way of example and without limitation, a compact disc (CD) or a universal serial bus (USB) flash drive. Media content elements may then be stored locally on a hard drive of the webinar generation device 110. As one of ordinary skill will appreciate, the media content elements may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. Media content elements also may be encoded in other formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), or any number of other digital formats.

Media interface 112 may also be configured to receive media content elements directly from a digital recording device 107, which may use an associated cable 111 or other interface for coupling digital recording device 107 to webinar generation device 110. Webinar generation device 110 may support any of a number of common computer interfaces, such as, but not limited to IEEE-1394 High Performance Serial Bus (Firewire), USB, a serial connection, and a parallel connection. Although not shown in FIG. 1, digital recording device 107 may also be coupled to the webinar generation device 110 over a wireless connection or other communication path.

Webinar generation device 110 may be coupled to a network 117 (such as, for example, the Internet, intranets, extranets, wide area networks (WANs), local area networks (LANs), wired networks, wireless networks, or other suitable networks, etc., or any combination of two or more such networks). Through the network 117, the webinar generation device 110 may receive media content elements from another computing system (e.g., system 103). Additionally or alternatively, webinar generation device 110 may access one or more media content element-sharing websites (e.g., website 134 hosted on a server 137) via network 117 in order to receive one or more media content elements.

A webinar manager 114 executes on a processor of webinar generation device 110 and configures the processor to perform various operations/functions relating to management of media content elements for providing a presentation. For example, webinar manager 114 may be configured to receive a plurality of media content elements, as well as a user input designating the plurality of media content elements in a predetermined order for forming a presentation. Additionally, webinar manager 114 may be configured to receive a subsequent user input for initiating broadcasting of the plurality of media content elements as a webinar based on the predetermined order. Specifically, broadcasting of the webinar by the user (i.e., the presenter) makes the presentation (i.e., the compilation of media content elements) available for interaction (e.g., viewing, listening, etc.) by one or more participants in the webinar via a suitable network-connected system (e.g., computing system 103).

A user interface (UI) generator 116 is executed to generate a user interface for allowing a user (e.g., the presenter) to view, arrange, modify and/or broadcast the one or more media content elements of a presentation. The user interface (an example of which will be described later) allows the user to provide user inputs, such as those associated with: designating media content elements in a predetermined order; initiating broadcasting of a webinar; selecting one or more of the media content elements; and, modifying the selected media content elements (e.g., modifying in real-time during broadcasting), among possible others.

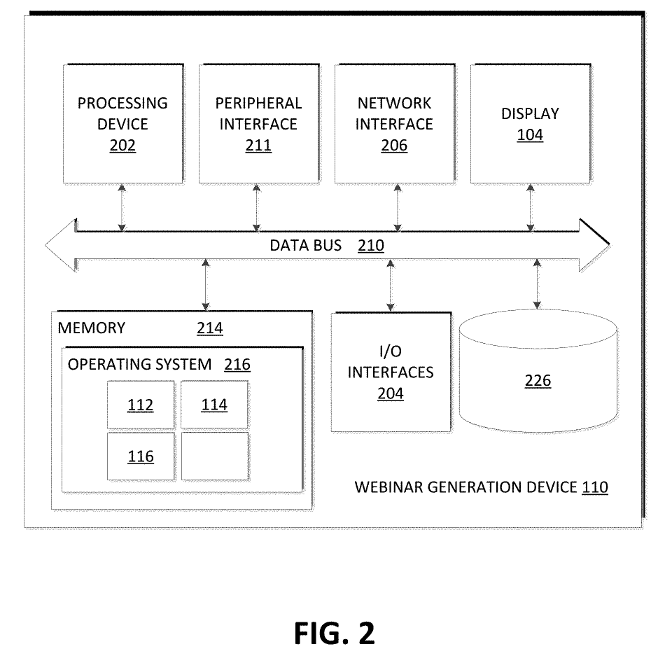

As shown in FIG. 2, webinar generation device 110 may be embodied in any of a wide variety of wired and/or wireless computing devices, such as a desktop computer, portable computer, dedicated server computer, multiprocessor computing device, smart phone, tablet, and so forth. Specifically, in this embodiment, webinar generation device 110 incorporates a memory 214, a processing device 202, a number of input/output interfaces 204, a network interface 206, a display 104, a peripheral interface 211, and mass storage 226, with each of these components being connected across a local data bus 210.

The processing device 202 may include a custom-made or commercially-available processor, a central processing unit (CPU) or an auxiliary processor among several processors associated with the media editing device 102, a semiconductor-based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software, which may comprise some or all the components of webinar generation device 110. In accordance with such embodiments, the components are stored in memory 214 and executed by the processing device 202, thereby causing the processing device 202 to perform the operations/functions relating to webinar management disclosed herein. One of ordinary skill in the art will appreciate that the memory 214 can, and typically will, comprise other components which have been omitted for purposes of brevity.

Input/output interfaces 204 provide any number of interfaces for the input and output of data. For example, where webinar generation device 110 comprises a personal computer, these components may interface with one or more user input/output interfaces 204, which may comprise a keyboard or a mouse. The display 104 may comprise a computer monitor, a plasma screen for a PC, a liquid crystal display (LCD) on a hand-held device, a touchscreen, or other display device.

In the context of this disclosure, a non-transitory computer-readable medium stores programs for use by or in connection with an instruction execution system, apparatus, or device. More specific examples of a computer-readable medium may include, by way of example and without limitation: a random access memory (RAM), a read-only memory (ROM), an erasable programmable read-only memory (EPROM, EEPROM, or Flash memory), and a portable compact disc read-only memory (CDROM) (optical).

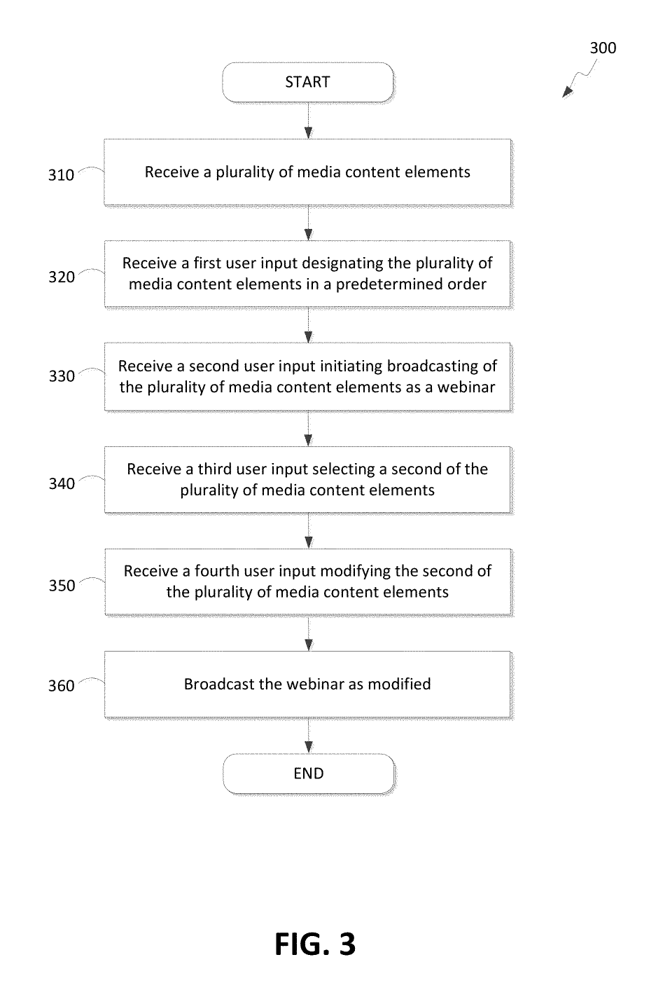

Reference is made to FIG. 3, which is a flowchart depicting an embodiment of a method 300 for providing webinars, such as may be performed by the system of FIG. 1. It should be understood that the flowchart of FIG. 3 depicts an example of steps that may be implemented in a webinar generation device. From an alternative perspective, the flowchart of FIG. 3 provides an example of the different types of functional arrangements that may be employed to implement the operation of the various components of webinar generation device according to one or more embodiments. Although FIG. 3 shows a specific order of execution, it should also be understood that the order of execution may differ from that which is depicted in some embodiments. For example, the order of execution of two or more blocks may be scrambled relative to the order shown. Also, two or more blocks shown in succession in FIG. 3 may be executed concurrently or with partial concurrence. All such variations are within the scope of the present disclosure.

In this regard, method 300 may be construed as beginning at block 310, in which a plurality of media content elements is received. In block 320, a first user input is received that is configured to designate the plurality of media content elements in a predetermined order. Then, in block 330, a second user input is received that is configured to initiate broadcasting of the plurality of media content elements as a webinar based on the predetermined order. Notably, when broadcast, a first of the plurality of media content elements is available for interaction by at least a first participant of the webinar. As depicted in block 340, a third user input is received that is configured to select a second of the plurality of media content elements and, in block 350, a fourth user input is received that is configured to modify the selected media content element (in this case, the second of the plurality of media content elements). In some embodiment, the receiving of the third user input and the receiving of the fourth user input occur during the broadcasting of the webinar.

Thereafter, such as depicted in block 360, the broadcasting of the webinar is modified in response to the fourth user input. In particular, the second of the plurality of media content elements is broadcast in a manner based on the fourth user input. In some embodiments, this may involve altering a position of the second of the plurality of media content elements in the predetermined order for broadcasting and/or editing content of the media content element itself. It should be noted that, depending on the modification performed, the predetermined order of the plurality of media content elements may remain unaltered. However, some modifications may involve altering sequencing of the plurality of media content elements within the predetermined order such that one or more of the media content elements is reordered with respect to others. By way of example, in some modifications of the presentation, one or more additional media content elements may be added to the webinar. With reference to a predetermined order that includes a first media content element followed by a second media content element, adding of an additional media content may be performed by modifying the predetermined order to sequence the additional media content element temporally adjacent to the second media content element (e.g., between the first media content element and the second media content element, or after the second media content element). In some embodiments, the additional media content may be created during the broadcasting of the webinar, providing true real-time update functionality.

In accordance with other modifications of the presentation, one or more media content elements may be deleted from the webinar.

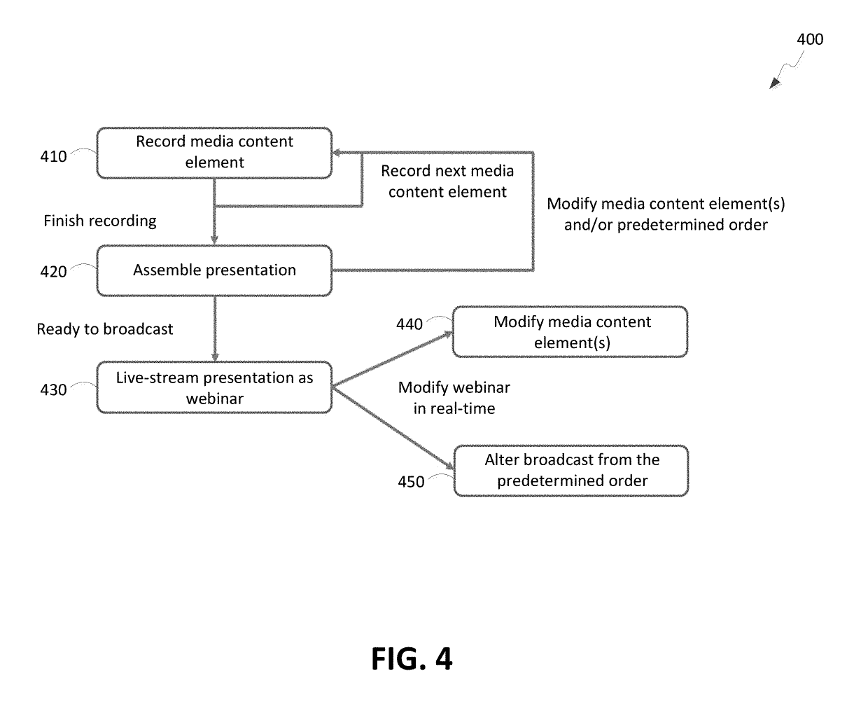

FIG. 4 is a flowchart depicting another embodiment of a method for providing webinars, such as may be performed by the system of FIG. 1. As shown in FIG. 4, method 400 may be construed as beginning at block 410, in which a media content element is recorded. As mentioned before, a media content element may comprise at least one of video, audio, slide, desktop screen capture, white board, annotation, and animation. Thus, as appropriate, such a media content element may be recorded (and optionally mixed) using a microphone, cell phone, audio file, and/or desktop sound, among other suitable components. The functionality depicted in FIG. 4 accommodates the recording of media content elements one by one, which may be accomplished by the user by repeating block 410 as desired. After recording is completed, the process proceeds to block 420, in which a presentation comprising one or more media content elements in a predetermined order are assembled. Prior to broadcasting (depicted in block 430), the user is able to modify one or more of the content items and/or the predetermined order. As shown, this may include returning to block 410 and recording one or more additional media content elements. Additionally or alternatively, this may involve preview and/or editing selected media content elements (e.g., re-record audio, video, slide, desktop screen capture, white board, annotation, and/or animation). For instance, in some embodiments, a user may preview each media content element in the designated predetermined order, and, optionally, and may select a media content element for editing. In some embodiments, this may include re-recording or deleting the previously-recorded media content element, or modifying the media content element in a different manner, such as by adding annotations. In some embodiments, an additional media content element may be added and a specific position among the predetermined order may be designated.

Once the presentation is suitably assembled, the process may proceed to block 430, in which the assembled presentation is live-streamed as a webinar so that the media content elements may be interacted with by a participant (e.g., received by a user via a desktop computer, a computer workstation, a laptop, or a mobile phone). During the webinar, the media content elements are broadcast one by one in the predetermined order. In some embodiments, a user input may be used to start the webinar schedule the webinar for start, thus enabling the webinar to start in response to a user input. During broadcast, various user customizations may be made to the webinar. By way of example, in some embodiments, a user may (based on corresponding input): pause/resume the broadcasting; jump to a desired media content element; insert a new media content element; and/or interact with the webinar participants, such as by talking in live camera view, drawing on the white board to answer questions, and/or having a text-based conversation with webinar participants.

Thereafter, such as depicted in blocks 440 and 450, one or more of various modifications may be performed in real-time during broadcasting of the webinar. In some embodiments, this may involve modifying one or more of the media content elements (block 440) and/or altering the broadcasting of the media content elements from the predetermined order (block 450).

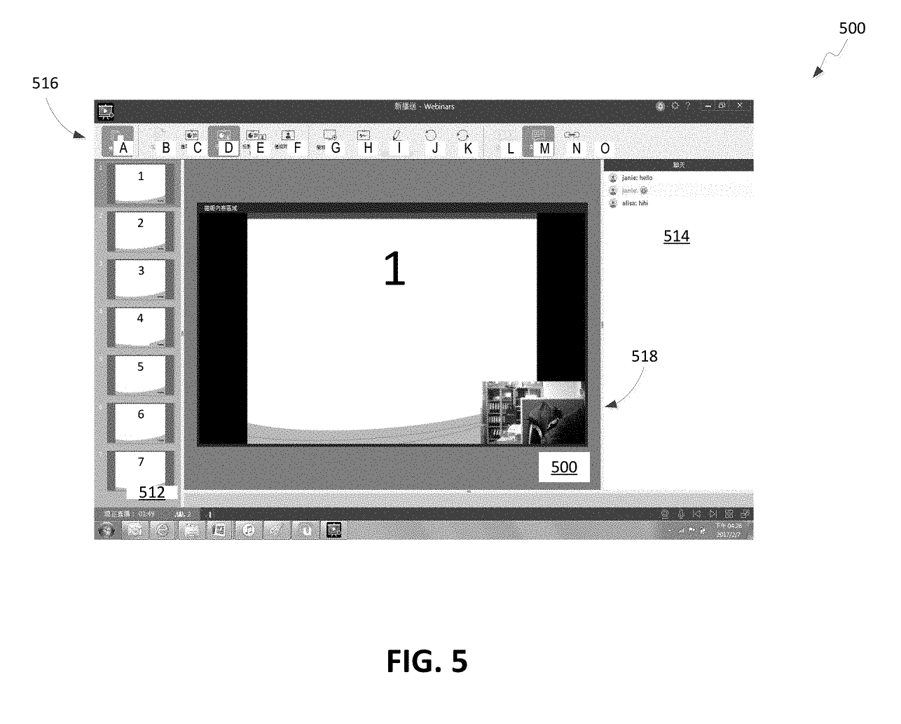

FIG. 5 illustrates an embodiment of a user interface (UI) 500 in a host webinar mode that may be provided by a webinar generation device. As shown in FIG. 5, UI 500 provides multiple display sections, such as presentation section 510, thumbnail section 512, chat section 514, and toolbar 516. Presentation section 510 is configured to provide content that corresponds to media content elements broadcast to participants of the webinar. In this example, a media content element “1” is being broadcast in a picture-in-picture (PIP) mode, with live video from a webcam being provided as the in-set picture 518. Note that media content element “1” is designated for broadcast in thumbnail section 512 (in this case, by highlighting), and icons A, D, and M of the toolbar are actuated/active. Specifically, icon A corresponds to a play/stop broadcast function, icon D corresponds to picture-in-picture (PIP) mode, and icon M corresponds to chat mode, which activates chat section 514.

Various other features of toolbar 516 may include, but are not limited to, an import file function (icon B, which is actuated to add a media content item), a slide-only mode (icon C), an aligned (side-by-side) mode (icon D), a webcam-only mode (icon E), a desktop screen-capture mode (icon G), a whiteboard mode (icon H), an annotate mode (icon I), an undo function (icon J), a reset function (icon K), an extend-monitor function (icon L), an text-chat function (icon m), a get-link function (icon N), and a be-right-back (BRB) function (icon O) 510.

When live broadcasting is started (such as by actuating icon A), UI 500 enables the display of all of the media content elements in the predetermined order depicted in thumbnail section 512. However, the presenter may choose to alter the predetermined order and/or skip (jump) one or more of the media content elements and/or insert one or more additional media content elements. So provided, while broadcasting the webinar, the presenter may perform various real-time modifications, such as jumping to another video, switching to a live broadcast, adding an additional media content element, changing the order of the media content elements, interacting with audiences, and writing on the whiteboard.

Finally, when live broadcasting is finished, the presenter may save the broadcast (e.g., save the broadcast to a server) so that the broadcast may be watched at a later time (i.e., on demand).

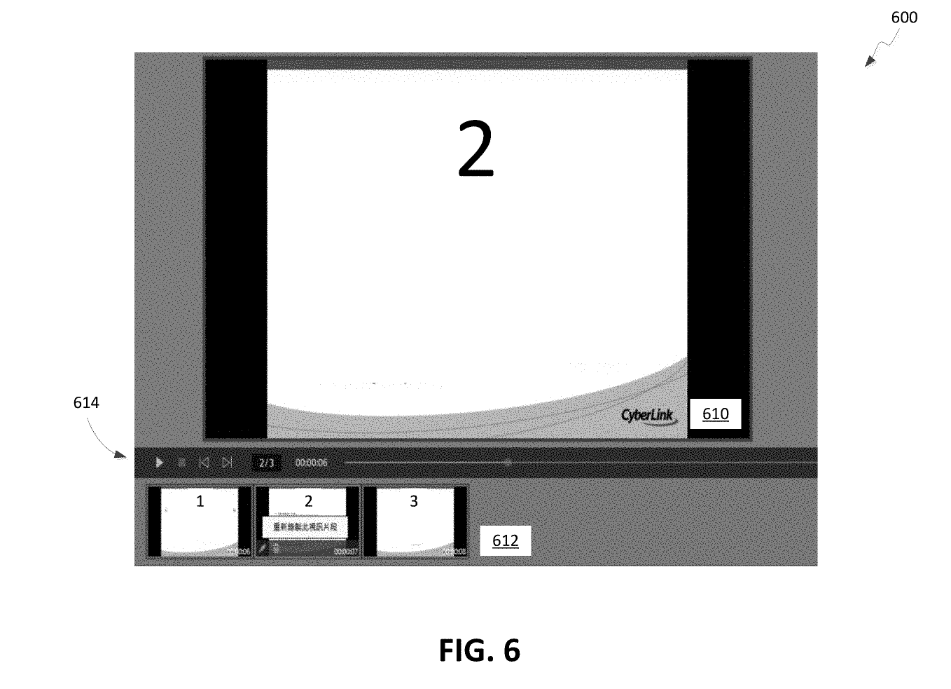

FIG. 6 illustrates an embodiment of an example user interface operating in a record/edit mode during broadcasting. As shown in FIG. 6, UI 600 provides a presentation section 610 and a thumbnail section 612, separated by a run-time indicator 614. A user may find this mode useful for creating or modifying presentations, such as by editing, deleting and/or adding one or more media content elements. With respect to creating a presentation, the record/edit mode may be launched, such as in response to actuation of a corresponding icon (e.g., a “record new webinar” icon, not shown). Thereafter, the user is provided with UI 600, which may be populated with one or more media content items (e.g., media content items 1-3) to form a presentation. Alternatively, an existing presentation may be modified, such as by actuating an associated icon (e.g., a “continue previous recording” icon or an “edit webinar” icon, neither of which is shown). In this regard, edit webinar may include adding text, video effects, adjusting playback time and/or adjusting play speed.

In this regard, editing may also be performed by selecting a media content element (such as media content element 2 as depicted). Then, the user may utilize the original slide to re-record audio, video, slide, desktop screen capture, whiteboard, annotation, and/or animation to edit the media content element without changing the order of the media content elements. Similarly, a selected media content element may be deleted without affecting the order of others of the media content elements. Additionally or alternatively, one or more additional media content elements may be added.

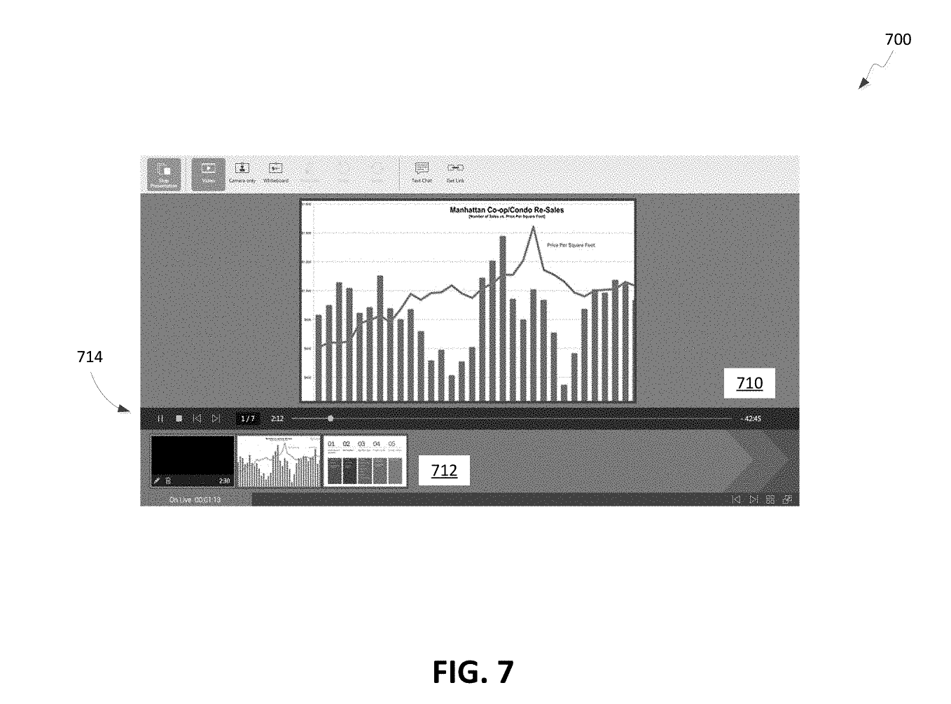

FIG. 7 illustrates an embodiment of an example user interface operating in a broadcast recorded webinar mode showing compatibility with different types of media content elements. As shown in FIG. 7, UI 700, which may be displayed i response to actuation of an actuator (e.g., a “broadcast recorded webinar” icon (not shown)) provides a presentation section 710 and a thumbnail section 712, separated by a run-time indicator 714.

When broadcasting of the recorded media content elements is started, UI 700 enables the display of all of the pre-recorded media content elements in the predetermined order depicted in thumbnail section 712. However, the presenter may choose to alter the predetermined order and/or skip (jump) one or more of the media content elements and/or insert one or more additional media content elements. So provided, while broadcasting the webinar, the presenter may perform various real-time modifications, such as jumping to another video, switching to a live broadcast, adding an additional media content element, changing the order of the media content elements, interacting with audiences, writing on the whiteboard, and/or switching back to play pre-recorded video, among numerous others. It should be noted that, in some embodiments, the broadcasting may be started or scheduled by a user. Additionally, a user may pause/resume the broadcasting manually by interacting with UI 700.

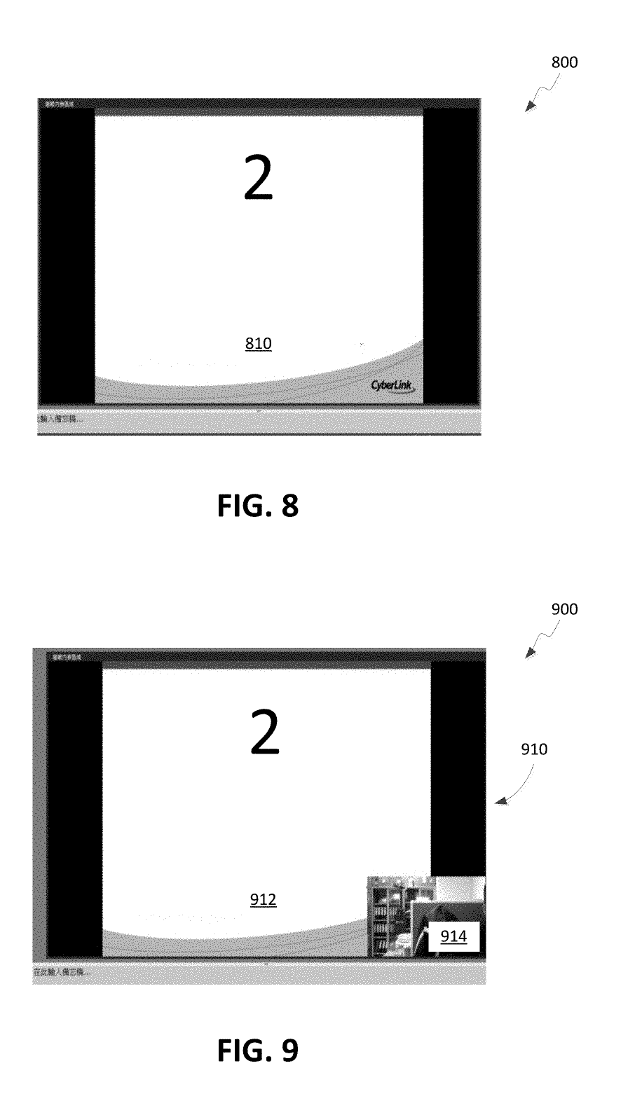

FIG. 8 illustrates another embodiment of an example user interface operating in a slide mode. In FIG. 8, UI 800 provides a presentation section 810 in which only the slide currently being broadcast is displayed. In some embodiments, a user may be able to provide annotations (such as by drawing annotations) on the slide.

FIG. 9 illustrates another embodiment of an example user interface operating in a picture-in-picture mode. As shown in FIG. 9, UI 900 provides a presentation section 910 that includes a main picture 912 and an in-set picture 914. In this example, main picture 912 is displaying a slide and in-set picture 914 is displaying live camera images; however, various other configurations and content types may be used.

FIG. 10 illustrates another embodiment of an example user interface operating in a side-by-side mode. As shown in FIG. 10, UI 1000 provides a presentation section 1010 that includes a main picture 1012 and a secondary picture 1014. In this example, main picture 1012 is displaying a slide and secondary picture 1014 is displaying live camera images; however, various other configurations and content types may be used. Note that, in contrast to the PIP mode, side-by-side mode does not result in overlap of the images presented.

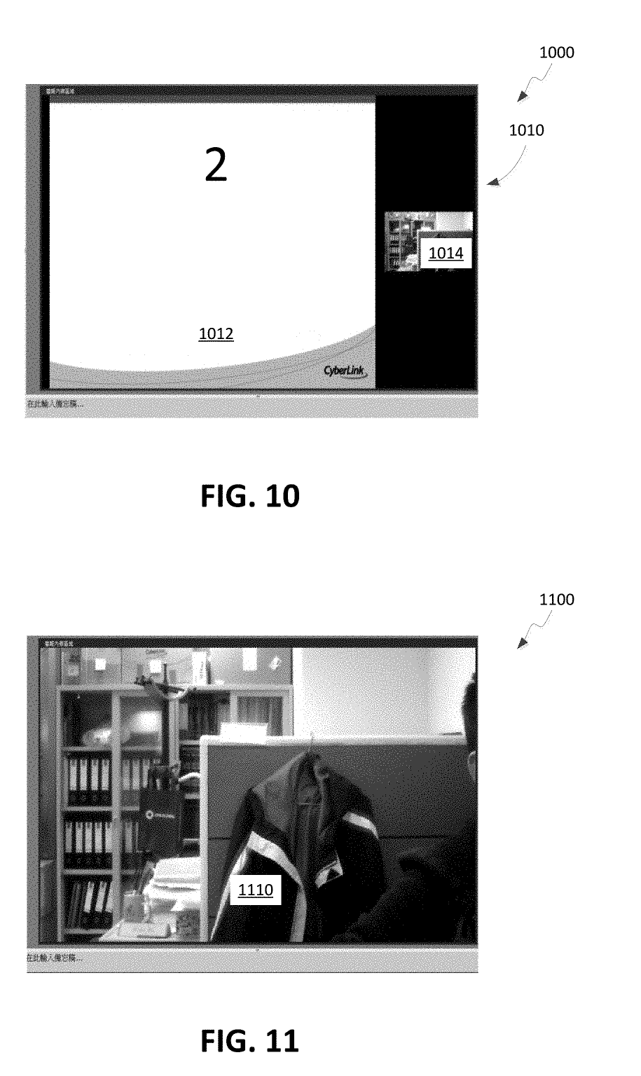

FIG. 11 illustrates another embodiment of an example user interface operating in a video mode. As shown in FIG. 11, UI 1100 provides a presentation section 1110, which displays only media content elements configured as video.

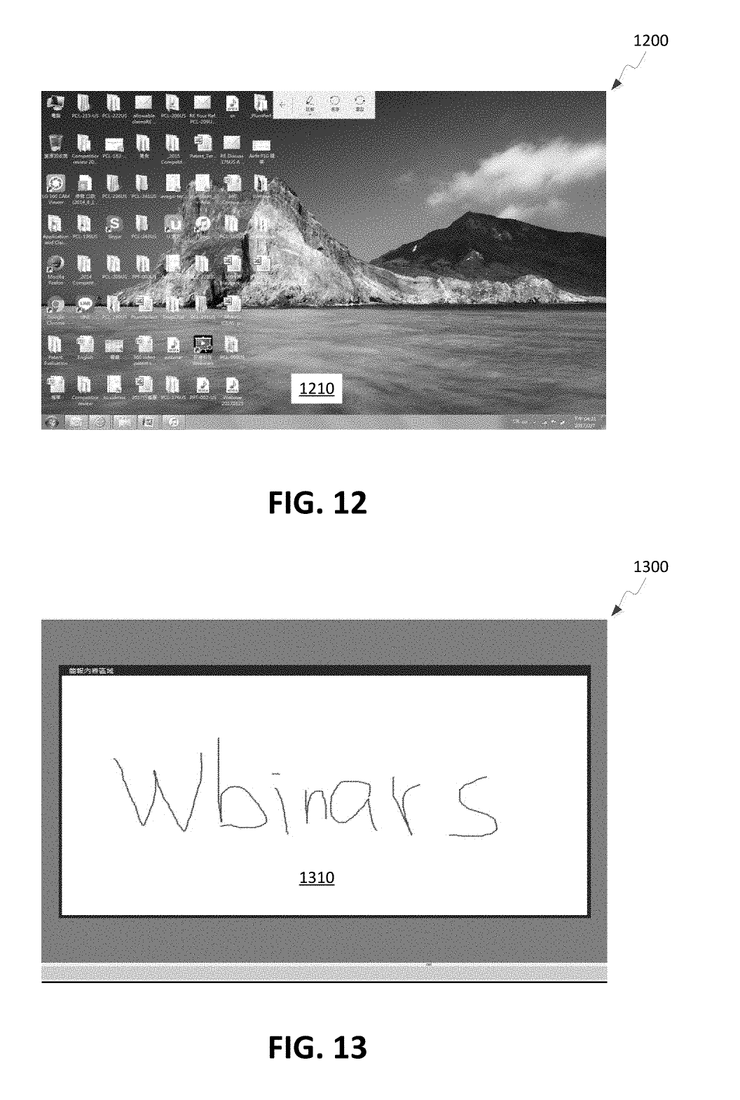

FIG. 12 illustrates another embodiment of an example user interface operating in a desktop screen-capture mode. As shown in FIG. 12, UI 1200 provides a presentation section 1210, which displays a current desktop configuration of the presenter.

FIG. 13 illustrates another embodiment of an example user interface operating in a whiteboard mode. As shown in FIG. 13, UI 1300 provides a presentation section 1310, which displays a representative whiteboard with which the presenter may provide real-time written/drawing content.

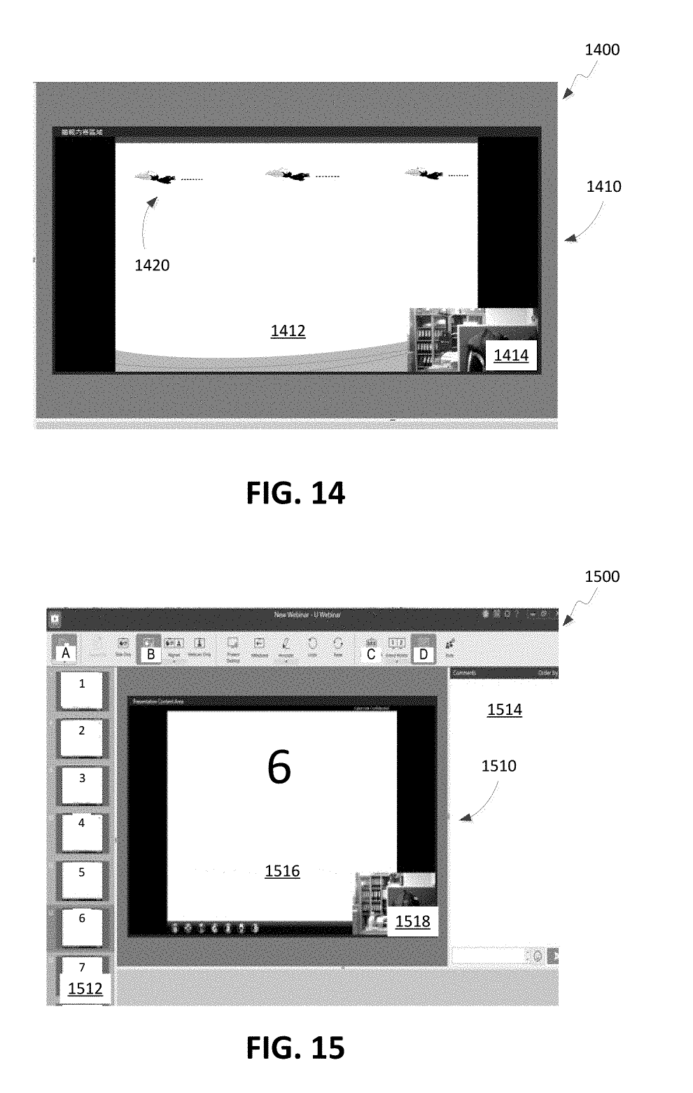

FIG. 14 illustrates another embodiment of an example user interface operating in an animation mode. As shown in FIG. 14, UI 1400 provides a presentation section 1410 that includes a main picture 1412 and a secondary picture 1414. In this example, main picture 1412 is displaying an animation 1420 and secondary picture 1414 is displaying live camera images.

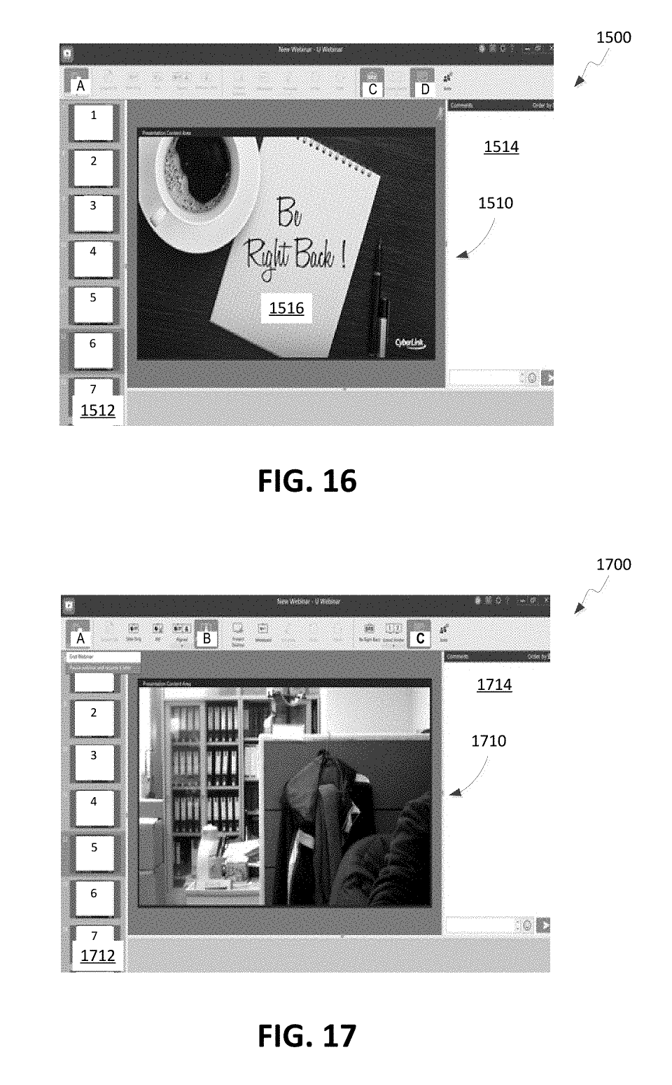

FIGS. 15 and 16 illustrate another embodiment of an example user interface. As shown in FIG. 15, UI 1500 provides a presentation section 1510, a thumbnail section 1512, and a chat section 1514 (which is enabled by actuation of icon C). During broadcasting (which is enabled by actuation of icon A), a picture-in-picture is enabled by actuation of icon B. In this example, a slide “6” is displayed in main picture 1516 and live video is displayed in secondary picture 1518. Also during broadcasting, a presenter may desire to pause the webinar. This may be accomplished by actuation of the be-right-back icon (icon C). In response to actuation of the be-right-back icon, UI 1500 (as shown in FIG. 16) is configured to display a predetermined slide (e.g., a “Be right back” slide) in main picture 1516 and the webinar is paused. Note that, in this embodiment, actuation of icon C also causes the secondary picture to no longer be displayed and any associated microphone may be muted.

FIGS. 17-19 illustrate another embodiment of an example user interface. As shown in FIG. 17, UI 1700 provides a presentation section 1710, a thumbnail section 1712, and a chat section 1714 (which is enabled by actuation of icon C). During broadcasting (which is enabled by actuation of icon A), a webcam-only mode is enabled by actuation of icon B. In this example, if the presenter desires pausing the webinar, this may be accomplished by actuating the stop icon (icon A).

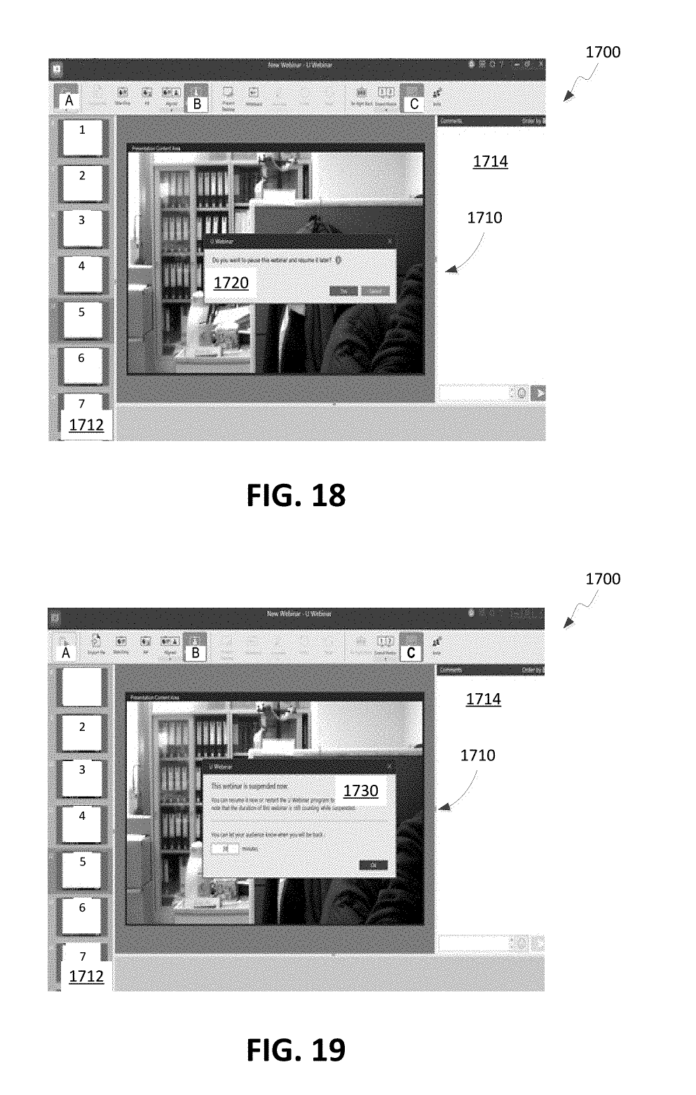

In response to actuation of the icon A, UI 1700 (as shown in FIG. 18) is configured to display a predetermined pop-up window 1720, which provides the presenter with an option of completing the pause process and resuming the webinar later. By way of example, the presenter may desire performing this functionality if the computer used for the webinar broadcast malfunctions. If the presenter indicates that the webinar is to be resumed later (such as by actuating the “Yes” actuator in pop-up window 1720), another pop-up window 1730 (FIG. 19) may be displayed. In window 19, the presenter may be prompted to enter an anticipated webinar pause time (30 minutes in this example), with this information being provided to any participants. In order to resume broadcasting, the presenter need only actuate icon A to resume streaming.

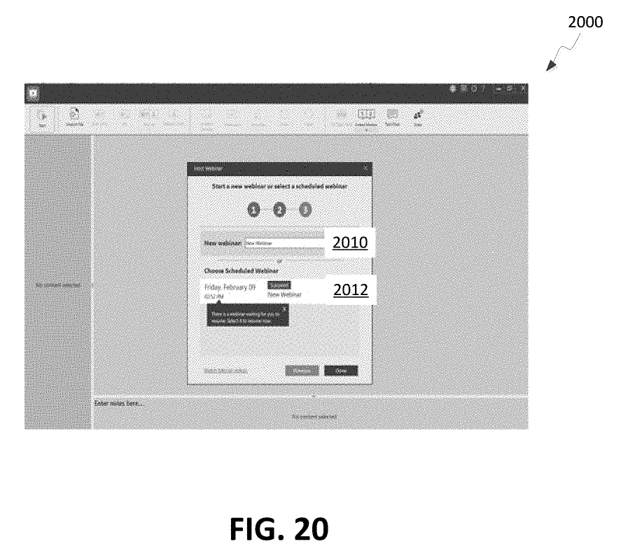

As mentioned before, a computer used for a webinar broadcast may malfunction, which may require the use of an alternate computer. Additionally or alternatively, a presenter may desire to begin another webinar. In these instances, a UI 2000 (FIG. 20) may be used. As shown in FIG. 20, which illustrates another embodiment of an example user interface, UI 2000 provides a search field 2010 for facilitating locating of a webinar for broadcast. Additionally, UI 2000 provides a list 2012 of scheduled webinars (such as webinars previously started and paused) that are available for broadcast (or resuming broadcast). After an appropriate webinar is selected, it may be started or resumed as appropriate. Notably, with respect to resumed broadcasts, participants previously attending the webinar do not need to be re-invited, as the participant list used during the previous broadcast is re-accessed.

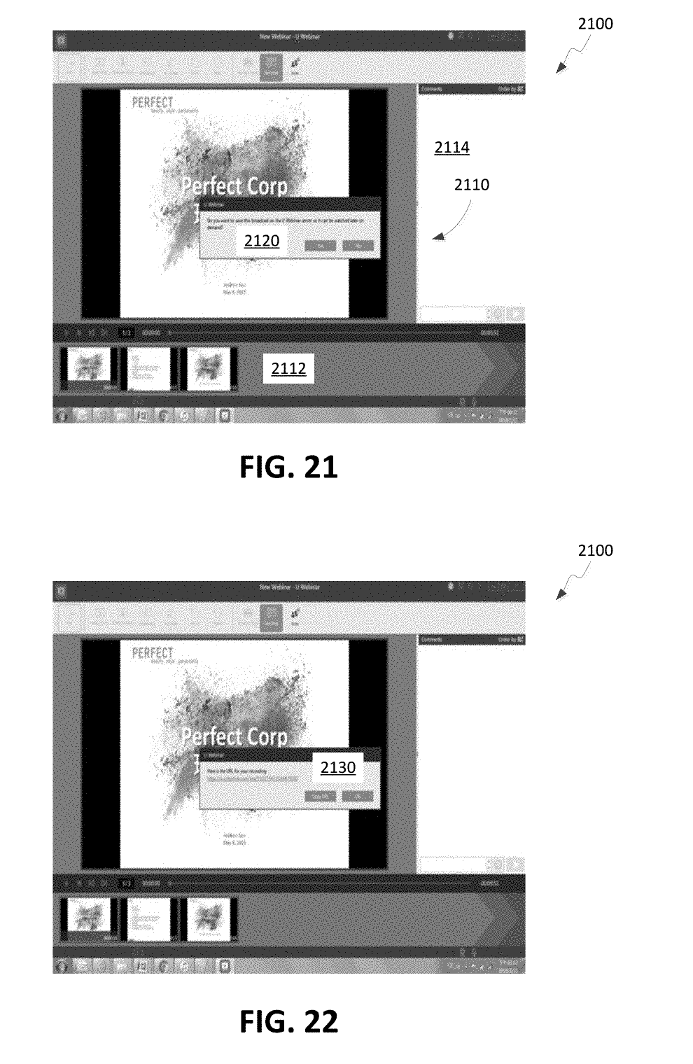

FIGS. 21-23 illustrate another embodiment of an example user interface. As shown in FIG. 21, UI 2100 provides a presentation section 2110, a thumbnail section 2112, and a chat section 2114. During broadcasting, a presenter may desire to pause the webinar, such as by actuation of a be-right-back icon (such as depicted in FIG. 16). In response to actuation of the be-right-back icon, UI 2100 is configured to display a predetermined slide (e.g., a “Be right back” slide) to participants of the webinar to indicate that the webinar is paused (not shown). Additionally, as shown in FIG. 21, UI 2100 is configured to provide a pop-up window 2120 in which a prompt is provided to determine whether the presenter desires to save the webinar to a server. If the presenter so desires (which may be indicated by actuating a “Yes” actuator), UI 2100 directs the saving of the webinar to an associated server.

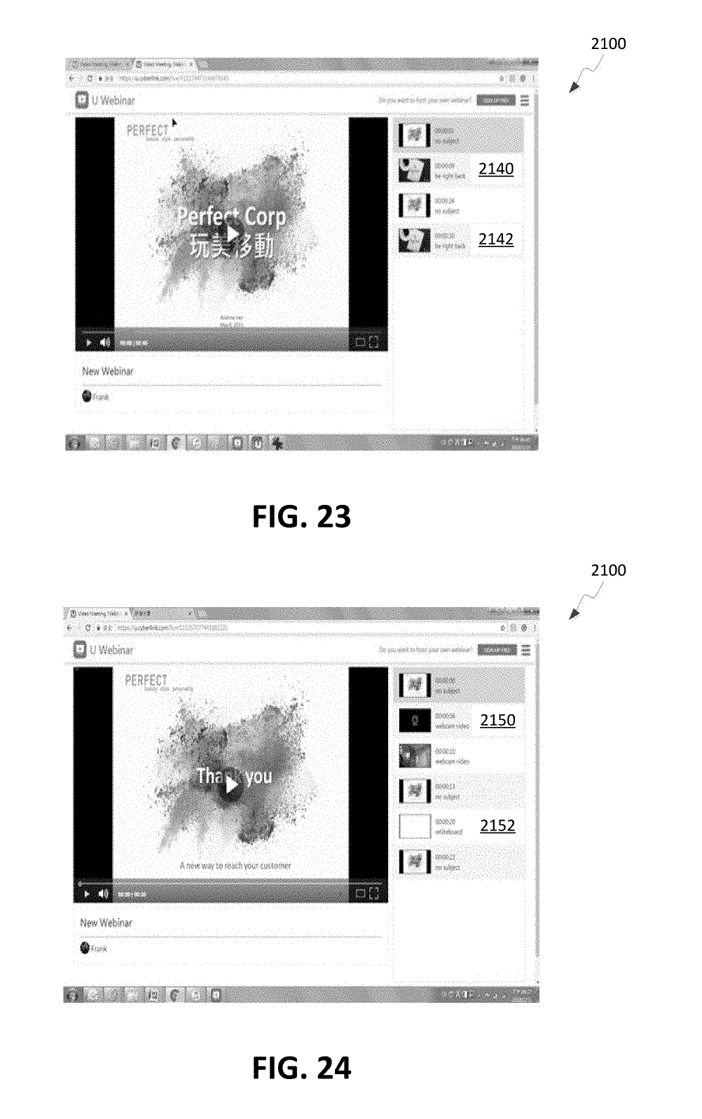

As shown in FIG. 22, in response to saving of the webinar, UI 2100 provides a pop-up window 2130, which provides information for accessing the saved webinar (e.g., a hyperlink) at a later time. Also, as shown in FIG. 23, after the webinar is saved, at least one additional media content element (e.g., element 2140 and 2142) may be added to the webinar and saved on the server for viewing later.

Alternatively, a user may create or modify presentations during a broadcasting (such as after actuating the “Be right back” button) by editing, deleting and/or adding one or more media content elements. With respect to creating a presentation, the record/edit mode may be launched, such as in response to actuation of a corresponding icon (e.g., a “record new webinar” icon, not shown). The user can edit the webinar, which may include one or more of adding text, video effects, jumping to another video, switching to a live broadcast, adding an additional media content element, and changing the order of the media content elements, for example.

In some embodiments, modifying may be performed during broadcasting with any additional media content elements being saved to the server. For example, the user pauses the broadcasting then the user adds media content elements of a video and a whiteboard. After the broadcast is saved on the server, the video and the whiteboard are added automatically, such as depicted by 2150 and 2152 in FIG. 24.

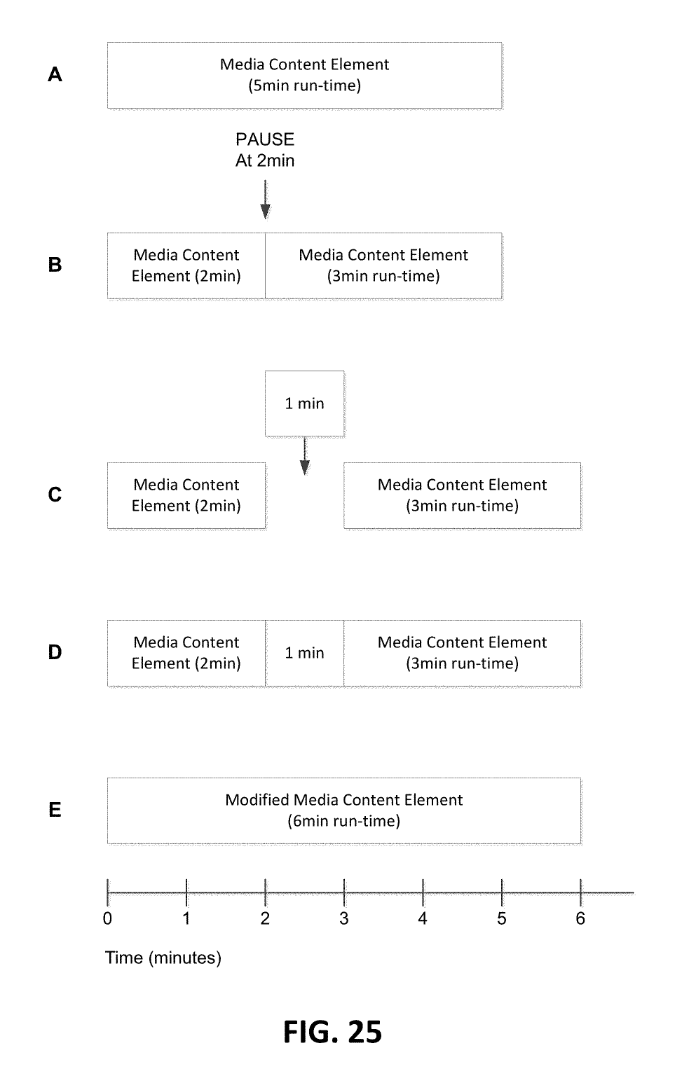

FIG. 25 is a schematic diagram illustrating an example method of modifying a media content element as may be performed using a UI. In this regard, an additional media content element can be inserted between two other media content elements (slides) or within a media content element. As shown in FIG. 25, modifying a media content element in this latter manner is shown in steps A-E. In step A, a media content element is provided that exhibits a run-time of 5 minutes. At step B, during broadcasting at time=2 min, the broadcasting is paused which designates a first portion of the content media element of 2 minutes in duration that has been broadcast, and a second portion of 3 minutes in duration that has not been broadcast. In step C, an additional media content element (with a 1-minute duration) is identified for use, and is inserted into the media content item at time=2 min. Thus, as depicted in step D, the original media content element that was 5 minutes in duration now comprises three media content elements (one of 2 minutes, 1 of 1 minute, and 1 of 3 minutes). The original media content element and the inserted additional media content element may then merged as depicted in step E to form a (single) modified media content element that exhibits 6 minutes in duration.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a webinar generation device for providing a webinar, comprising:
receiving a plurality of media content elements;
receiving a first user input designating the plurality of media content elements in a predetermined order;
receiving a second user input initiating broadcasting of the plurality of media content elements as a webinar based on the predetermined order;
receiving a third user input, during the broadcasting of the webinar, selecting a second of the plurality of media content elements; and
modifying the broadcasting of the webinar, in response to a fourth user input, such that the second of the plurality of media content elements is broadcast based on the fourth user input during the broadcasting of the webinar.

2. The method of claim 1, wherein, in broadcasting the plurality of media content elements as the webinar, a first of the plurality of media content elements is available for interaction by at least a first participant of the webinar.

3. The method of claim 1, wherein the modifying of the second of the plurality of media content elements comprises editing the second of the plurality of media content elements.

4. The method of claim 3, wherein, in modifying the broadcasting of the webinar, the predetermined order of the plurality of media content elements is unaltered.

5. The method of claim 1, wherein the modifying of the second of the plurality of media content elements comprises altering sequencing of the second of the plurality of media content elements within the predetermined order of the plurality of media content elements.

6. The method of claim 5, wherein:
the method further comprises adding an additional media content element to the webinar, and
the modifying of the second of the plurality of media content elements comprises modifying the predetermined order to sequence the additional media content element temporally adjacent to the second of the plurality of media content elements.

7. The method of claim 6, wherein the adding of the additional media content element comprises creating the additional media content during the broadcasting of the webinar.

8. The method of claim 1, wherein the modifying of the second of the plurality of media content elements comprises deleting the second of the plurality of media content elements from the webinar.

9. The method of claim 1, further comprising pausing the broadcasting of the webinar in response to a fifth user input.

10. A system for providing a webinar, comprising:
a memory storing instructions; and
a processor, having processor circuitry, coupled to the memory and configured by the instructions to:
receive a plurality of media content elements;
receive a first user input configured to designate the plurality of media content elements in a predetermined order;
receive a second user input configured to initiate broadcasting of the plurality of media content elements as a webinar based on the predetermined order;
receive, during the broadcasting of the webinar, a third user input configured to select a second of the plurality of media content elements; and
modify the broadcasting of the webinar, in response to a fourth user input, such that the second of the plurality of media content elements is broadcast based on the fourth user input during the broadcasting of the webinar.

11. The system of claim 10, in broadcasting the plurality of media content elements as the webinar, a first of the plurality of media content elements is available for interaction by at least a first participant of the webinar.

12. The system of claim 11, wherein the predetermined order of the plurality of media content elements is unaltered in response to the fourth user input.

13. The system of claim 10, wherein the fourth user input is configured to alter sequencing of the second of the plurality of media content elements within the predetermined order of the plurality of media content elements.

14. The system of claim 13, wherein:
the processor is further configured to receive an additional media content element; and
the fourth user input is configured to alter the predetermined order to sequence the additional media content element temporally adjacent to the second of the plurality of media content elements.

15. The system of claim 14, wherein the processor is further configured to permit receiving of the additional media content element during the broadcasting of the webinar.

16. A non-transitory computer-readable storage medium storing instructions to be implemented by a computing device having a processor, wherein the instructions, when executed by the processor, cause the computing device to perform steps, comprising:
receiving a plurality of media content elements;
receiving a first user input designating the plurality of media content elements in a predetermined order;
receiving a second user input initiating broadcasting of the plurality of media content elements as a webinar based on the predetermined order;
receiving, during the broadcasting of the webinar, a third user input selecting a second of the plurality of media content elements; and
modifying the broadcasting of the webinar, in response to a fourth user input, such that the second of the plurality of media content elements is broadcast based on the fourth user input during the broadcasting of the webinar.

17. The non-transitory computer-readable storage medium of claim 16, in broadcasting the plurality of media content elements as the webinar, a first of the plurality of media content elements is available for interaction by at least a first participant of the webinar.

18. The non-transitory computer-readable storage medium of claim 16, wherein the modifying of the second of the plurality of media content elements comprises editing the second of the plurality of media content elements.

19. The non-transitory computer-readable storage medium of claim 18, wherein, in modifying the broadcasting of the webinar, the predetermined order of the plurality of media content elements is unaltered.

20. The non-transitory computer-readable storage medium of claim 16, wherein the modifying of the second of the plurality of media content elements comprises altering sequencing of the second of the plurality of media content elements within the predetermined order of the plurality of media content elements.
